(19) United States
(12) Patent Application Publication
(10) Pub. No.: US 2006/0174167 A1
(43) Pub. Date: Aug. 3, 2006

(54) Self-creating maintenance database

(75) Inventor: Ryusuke Ito, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/245,693

(22) Filed: Oct. 7, 2005

Related U.S. Application Data
(60) Provisional application No. 60/648,238, filed on Jan. 28, 2005.

(51) Int. Cl. G06F 11/00

(52) U.S. Cl. 714/48

(57) ABSTRACT

A maintenance database is described. Maintenance entries are maintained in the maintenance database relating to repair actions for failure modes in a target system. The failed components of the target system are identified for each failure mode, and repair actions are recorded along with the sequence of repair actions for each failure mode. For a given subsequent failure mode, the corresponding bit pattern is determined and a match is found in the maintenance database. The corresponding maintenance entry of the matching bit pattern can then be used to repair the failure mode, or to serve as a basis for initiating the repair activity.

### CROSS-REFERENCES TO RELATED APPLICATIONS

This application is related to and claims priority from U.S. Provisional Application No. 60/648,238, filed Jan. 28, 2005, and is fully incorporated herein by reference for all purposes.

### BACKGROUND OF THE INVENTION

The present invention relates to maintenance of complex systems and in particular to the a database-driven approach to the repair of failures in a complex system.

High end computer systems (e.g., high-capacity storage systems, server farms, etc.) comprise large numbers of interconnected and interacting components. Consequently, failures in such a system can be complex and may require highly skilled personnel to troubleshoot and repair. Conventional methods for repairing such systems include the use pre-programmed repair actions, or activity directed by a manual.

For example, FIG. 8 illustrates a manual-based approach where various “failure points” in a computer system are identified. In this example, each constituent component in the computer system can be a failure point. A “maintenance action” is specified for each failure point, showing recovery activity of the failed component including any automated recovery actions and user repair actions. For example, if a channel processor fails, the computer system can perform an automatic “fail over” to another (backup) channel processor. Failures in other components are not recoverable. For example, a failure in a cache memory will result in “blockage” which is to say that operation of the computer system will cease. The maintenance action also shows the user repair action to be performed, which typically involves “exchanging” the failed component. A “reference action number” refers, for example, to a section in a repair manual to explain the repair procedure.

Conventional maintenance and repair procedures typically address a failure mode where only a single component has failed. Even then, a set of repair manuals for large complex computer systems may contain many volumes of manuals. It is seldom that only a single component will fail. More commonly, a failure mode involves some combination of many components experiencing failure, and in those situations the standard maintenance and repair manuals may not suffice to guide the repair technician to an effective repair solution. Largely, this is due to a high degree of integration and coordinated operation among the constituent components where the enumeration of every possible failure mode and corresponding repair action is not possible.

Consequently, the repair of a complex failure mode requires highly skilled personnel and is a time consuming operation. The resulting downtime of the computer system is not acceptable. The resulting increase in TCO (total cost to operate) and loss of business opportunity is also not acceptable.

### BRIEF SUMMARY OF THE INVENTION

A maintenance database comprises one or more maintenance entries relating to repair actions for failure modes in a target system. The failed components of the target system are identified for each failure mode, and repair actions are recorded along with the sequence of repair actions for each failure mode.

For a given subsequent failure mode, the corresponding bit pattern is determined and a match is found in the maintenance database. The corresponding maintenance entry of the matching bit pattern can then be used to repair the failure mode, or to serve as a basis for initiating the repair activity.

### BRIEF DESCRIPTION OF THE DRAWINGS

FIG. 1 illustrates a maintenance database configuration according to an illustrative embodiment of the present invention;

FIG. 2 highlights various aspects of the database of the present invention;

FIGS. 3A-3M shows a sequence illustrating user interaction to create a maintenance entry;

FIG. 4 illustrates dissemination of maintenance entries among databases;

FIG. 5 illustrates dissemination of maintenance entries generated from controlled failures;

FIGS. 6A-6D shows changes to a database when maintenance entries are disseminated;

FIG. 7 is a high level flow chart illustrating how a maintenance action is initiated to repair a failure condition in a target system; and

FIG. 8 shows a convention manual-based repair scheme.

### DETAILED DESCRIPTION OF THE INVENTION

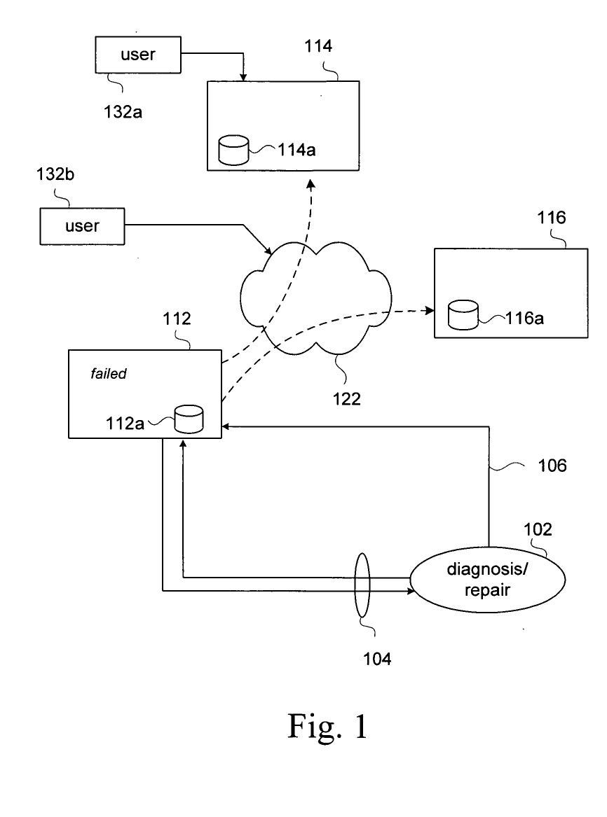

Various aspects of the present invention are illustrated in the configuration shown in FIG. 1. A target computer system 112 is shown indicating that it is in a failed condition, where some number of its constituent components have failed. A diagnosis and repair entity 102 is shown interacting with the target computer system 112 to effect its repair. The repair entity 102 may be a single person attempting the repair, or a team of people coordinating their efforts to effect a repair.

The interaction between the repair entity 102 and the target computer system 10 is shown by reference numeral 104. The interaction includes information that may be provided by the target computer system 10 to the repair entity 102 such as indicators on a component, a video display with textual and/or graphical information, and so on. The interaction also includes physical activity performed on the target computer system 112 such as exchanging components, pressing buttons or levers or such to initiate a restart sequence in a component, cycling the power switch to a component, and so on.

Information 106 relating to the repair activity performed by the repair entity 102 is provided to a self-creating maintenance (SCM) database 112a contained in the target computer system. FIG. 1 illustrates that the SCM database 112a is an integral component of the target computer system 112. As will be discussed below, this facilitates monitoring processes and/or sensors in the target computer system 112 to interact with the SCM database 112a, to automatically trigger maintenance actions. It will be appreciated that the SCM database 112a need not be physically integrated, but only that the functionality be integrated with the operation of the target computer system 112.

FIG. 1 shows additional computer systems 114 and 116, each having their corresponding SCM databases 114a, 116a. The computer systems 112-116 can be any sufficiently complex system that is suited for the detection and processing of failures and repair activity according to the present invention.

Each information system 112-116 is associated with its SCM database, respectively, 112a-116a. Any suitable database system can be used; for example, a commonly used database is a relational database using SQL (sequential query language) as the access language. Likewise, any suitable computer system can be used to implement an information management system.

Users 132a, 132b can access the SCM databases 112a-116a either via a direct connection to the information system or remotely. FIG. 1 shows user 132a connected to the computer system 114, for example, via a system console. User 132b has remote access capability, for example, by a dial-in connection or a via WEB server. Access by the remote user 132b can be limited to one or more of the computer systems 112-116.

Communication network 122 represents any of a number of communication channels that allow for communication among some of the information systems. Typical conventional communication channels are based on local area networks, wide area networks, virtual personal networks, and the Internet. Of course, other suitable communication networks can be used.

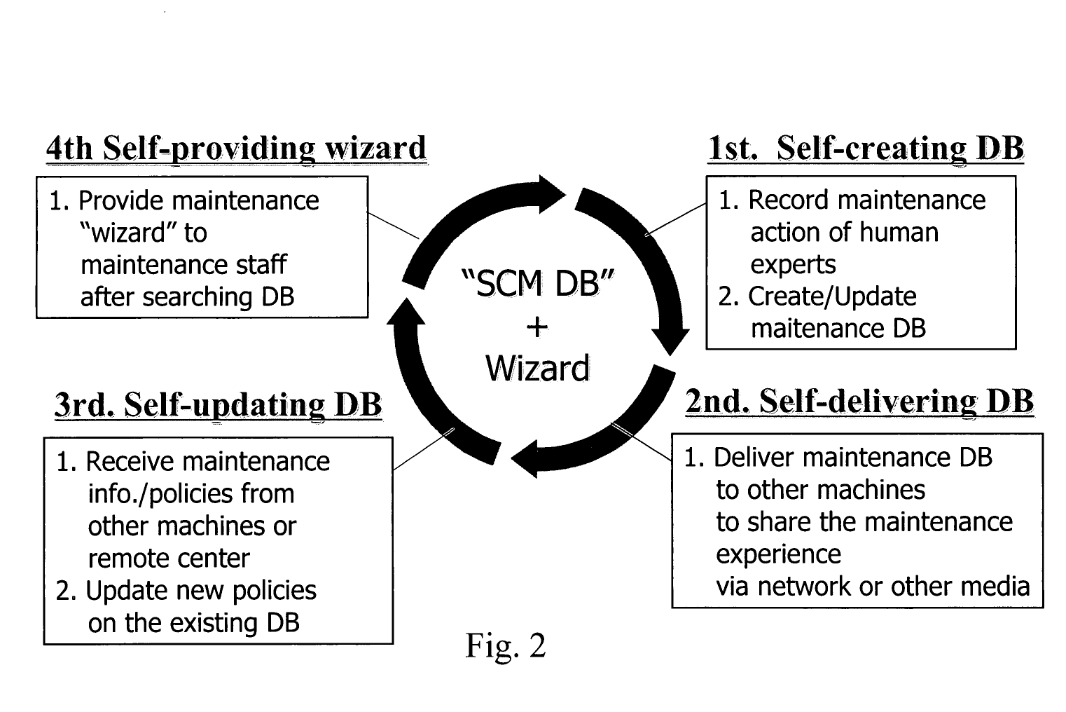

FIG. 2 shows characteristics of the SCM database 112a of the present invention. The SCM database is self-creating. The information system receives failure information and repair activity information for storage into the database. The information will typically originate from repair personnel, and represents the action or actions taken to effect repair of a failure condition of the target computer system. The SCM database is thereby created and updated by receiving such information. The SCM database stores the failure condition and subsequent repair action(s) as a “maintenance entry”. Depending on the particulars of the database, a maintenance entry may constitute one or more records of the underlying database.

The SCM database is self-delivering. The information (maintenance entries) collected in one SCM database (e.g., database 112a) can be provided to other SCM databases (e.g., 114a). This sharing of maintenance entries among databases can occur autonomously, and results in the databases learning from one another. Alternatively, the sharing can be manually performed.

The SCM database is self-updating. As will be explained maintenance entries include maintenance information and policies that are associated with their corresponding failure conditions and repair actions. When a policy in an information system is revised, updated, or otherwise evolves, it can be delivered to other information systems. In this way, the SCM database in the information system that receives the updated policy remains current.

Data Collection

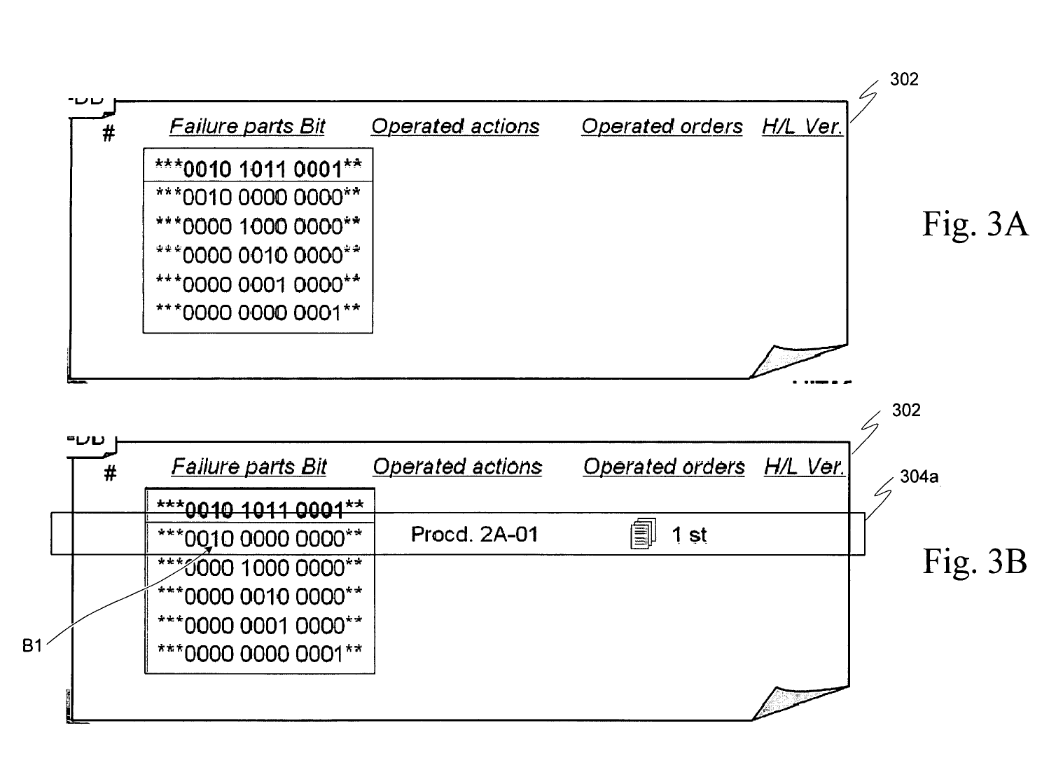

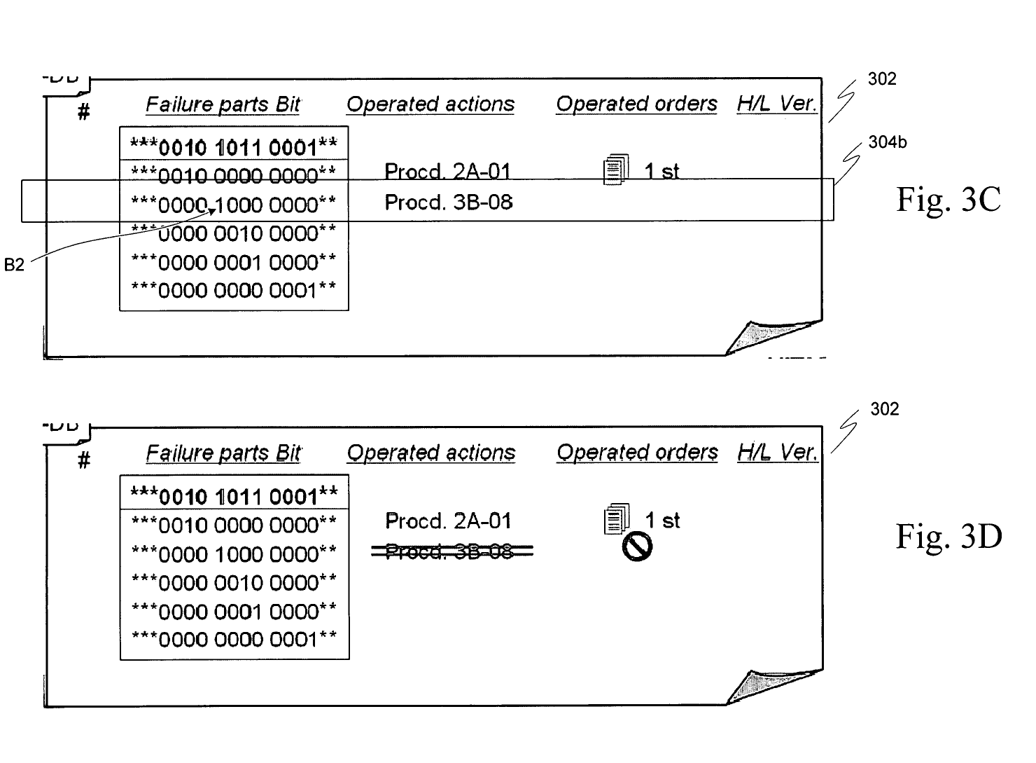

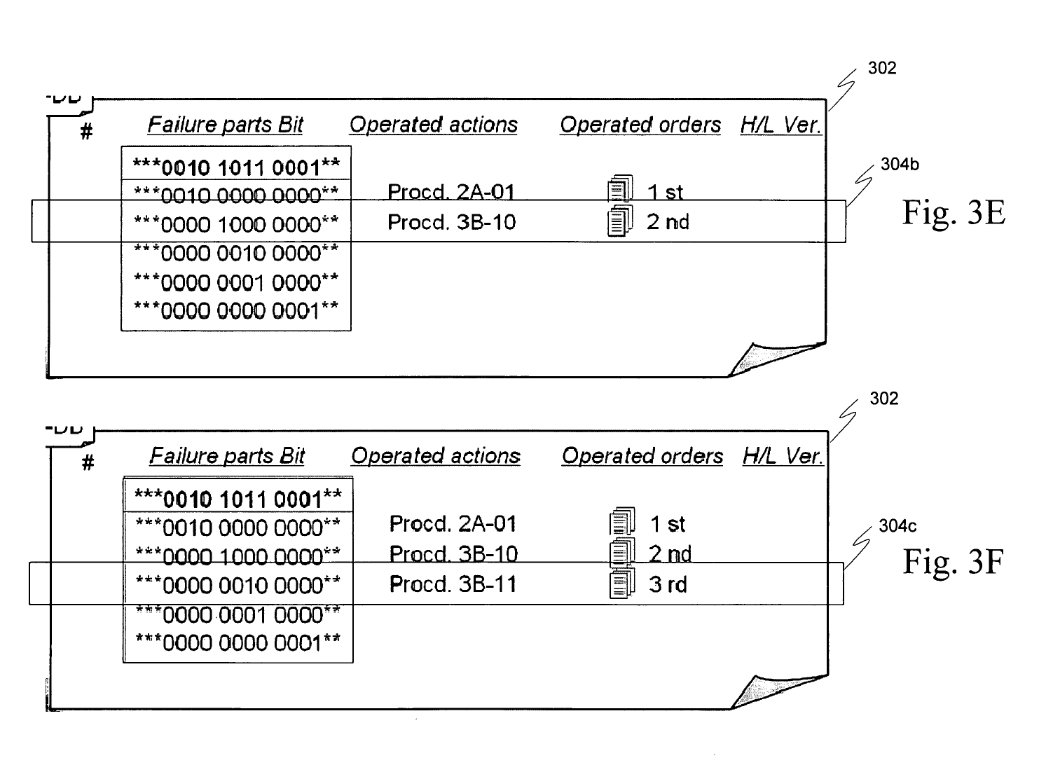

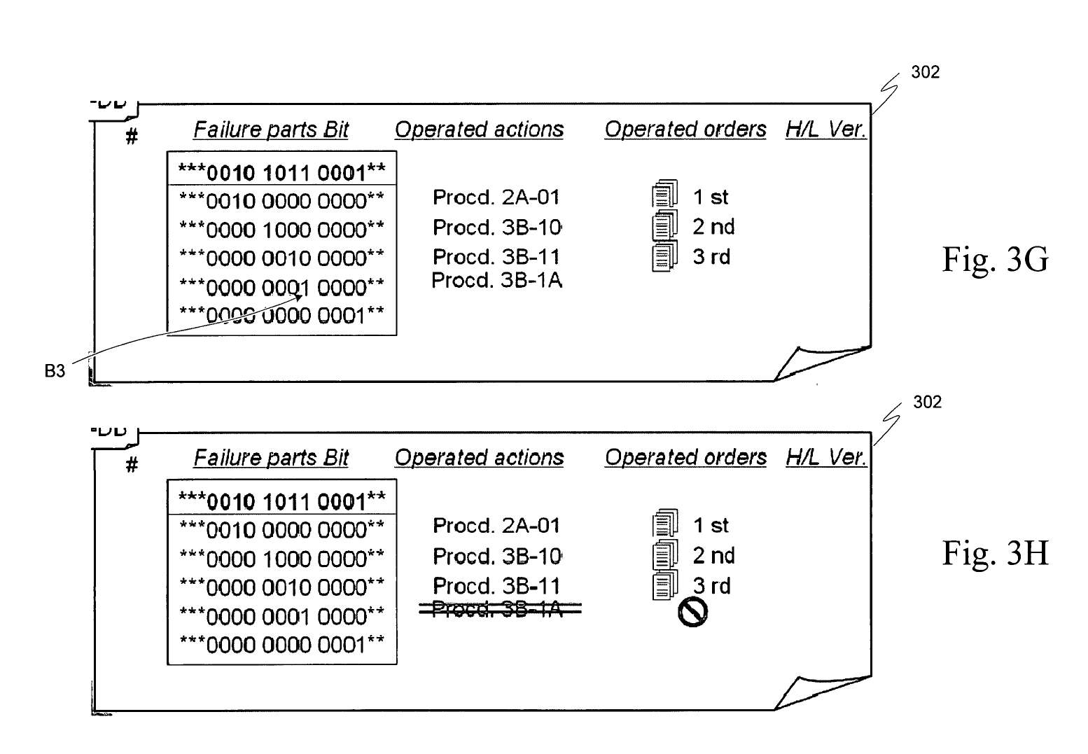

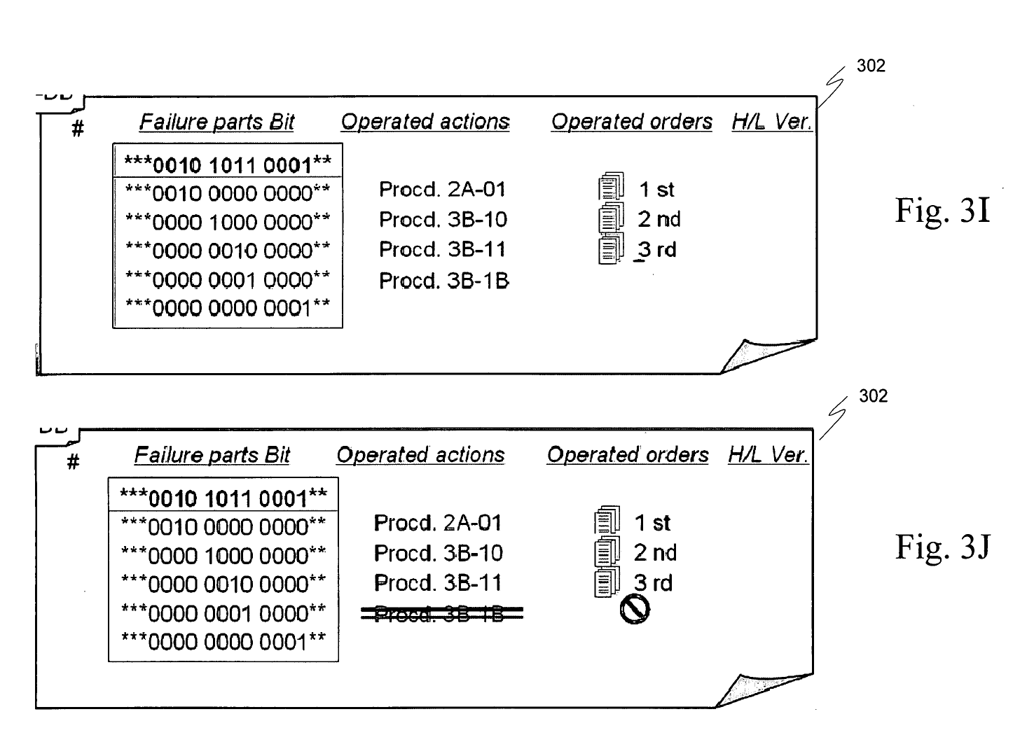

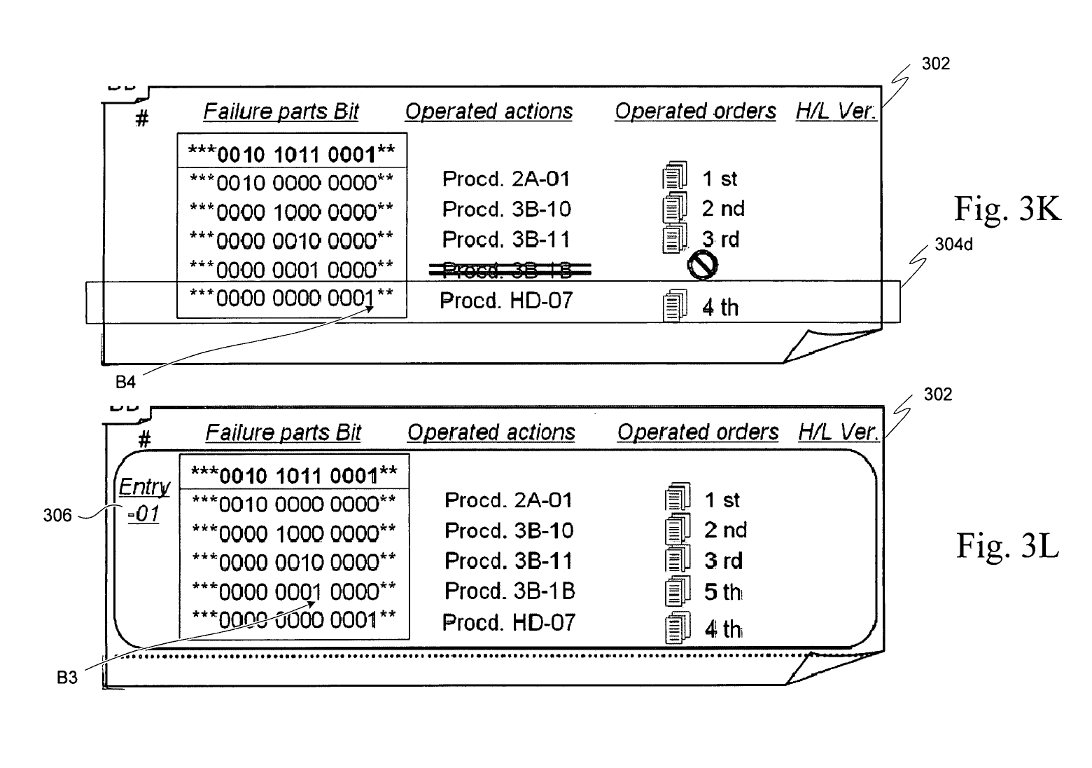

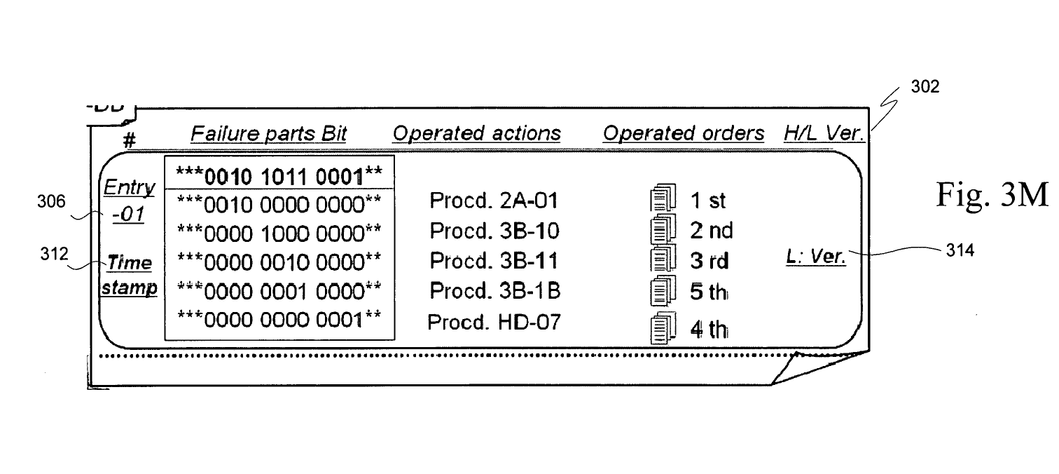

Refer now to the sequence shown in FIGS. 3A-3M. This sequence illustrates how the information for a maintenance entry in the SCM database 112a can be generated. The sequence of figures: (1) represents the information that is collected or otherwise obtained by a repair entity 102 and stored in the SCM database as a maintenance entry; and (2) serves as a simple example of a user interface for entering the information comprising the maintenance entry.

Typically, a failure condition in a target computer system (e.g., system 112 in FIG. 1) will initiate a repair action. Alternatively, a warning indication suggesting the possibility of a failure condition can trigger the onset of a repair action. A change in system performance can also serve as an initiating trigger; for example, slow performance in a WEB server might indicate a disk subsystem that is experience large numbers of read or write errors, but is otherwise functional. For discussion purposes, and such triggering event will be referred to as a failure condition or a failure mode. Thus, a failed component can be deemed to be a component that exhibits poor performance.

A repair entity 102 (e.g., a technician), upon inspection of the target computer system, identifies the component(s) of the failure condition and informs the SCM database. As discussed above, a suitable user interface can be provided to input such information. For example, FIG. 3A shows the content of a maintenance entry and serves to illustrate how the information can be entered in a user interface. A “failure parts bit” field identifies the failed components for a given failure condition. In a specific embodiment of the present invention disclosed herein, each component in the target computer system that can fail is assigned to a bit in a string of bits, referred to as a “component bit string.”

As a very simple example, consider a personal computer system. The components may include a CPU, a RAM (random access memory), a cache memory, a hard drive, a floppy drive, and a CD drive. The CPU may be associated with bit position 0 (least significant bit, LSB) of a six-bit component bit string. The RAM may be associated with bit position 1, the cache memory may be associated with bit position 2, the hard drive may be associated with bit position 3, the floppy drive may be associated with bit position 4, and the CD drive may be associated with bit position 5 (most significant bit, MSB). Thus a failed CPU and a failed floppy drive would be represented by the bit pattern “0 1 0 0 0 1”, where an ON bit represents a failed component. Six bits are used to represent this trivial system. However, a typical complex computer system is likely to comprise many hundreds of components and thus would be represented by a bit pattern of hundreds of bits.

The determination as to what constitutes a “component” in the system and whether it can “fail” depends on the system and is predetermined. For example, a disk drive is likely to be deemed a component that can fail. A component can be a group of similar devices. For example, an ECC (error correcting code) group in a RAID 5 system comprises a parity disk and a plurality of data disks; the ECC group can be considered a component and would be represented a bit. By convention, the bit corresponding to a failed component is set to a bit state of logic “1”, and is set to a bit state of logic “0” otherwise. The bit pattern associated with a failure condition therefore shows the combination of components that have failed.

The example in FIG. 3A shows only a portion of the component bit string for discussion purposes, illustrating an example of a failure condition in which five components have failed. A repair entity 102 upon inspecting the target computer system via a suitable interface identifies the components that have failed and that information is entered into the SCM database, setting the corresponding bit of each failed component.

FIG. 3B shows the state of the maintenance entry after performing a first repair action. The maintenance entry includes an “operated actions” field. This field contains a reference to a procedure that was used to repair the corresponding failed component. An “operated orders” field indicates the order in which the sequence of repair procedures were performed to effect repair of the target system for this particular combination of failed components. FIG. 3B shows a first repair entry 304a in which a repair procedure identified as “Procd. 2A-01” was performed to repair the component identified by the bit B1.

FIG. 3C shows a second repair entry 304b in which a second repair action was performed in an attempt to repair the failed component identified by the bit B2. The entry in the “operated actions” field shows that a procedure referred to as “Procd. 3B-08” was applied to repair the failed component. However, let us assume that the procedure was ineffective. As can be seen in FIG. 3D, the user interface can be provided with a mechanism to correct the repair entry. FIG. 3D shows that the user has struck the repair action. FIG. 3E shows that a successful repair action was performed on the component B2. The second repair entry 304b indicates that the second repair action is a procedure identified as “Procd. 3B-10”. FIG. 3F shows a third repair entry 304c, showing a third repair action.

FIG. 3G shows a fourth repair action performed by the repair entity 102 on the component identified by bit B3. As can be seen in FIG. 3H, the entry is deleted indicating that the repair action was not successful. FIG. 31 shows that new entry was made, indicating another attempt at repairing component B3. However, FIG. 3J shows that this entry is deleted, indicating another failed attempt at repairing component B3.

FIG. 3K shows that the user interface allows the user to skip to another component. In this case, the repair entity 102 decided that component B3 should be skipped and that the component identified by bit B4 should be repaired before repairing component B3. FIG. 3K shows that a successful repair action was made on component B4, namely, procedure “HD-07 ” was performed on component B4. This action constitutes the fourth repair action 304d.

FIG. 3L shows that the component identified by bit B3 was repaired using procedure “Procd. 3B-1B” and was the fifth and final action to be performed in order to repair the failure condition. The figure shows an entry identifier 306 has been assigned to the maintenance entry 302 by the SCM database. Moreover, the identifier 306 identifies the combination of failed components.

FIG. 3M shows additional information that can be associated with the maintenance entry 302. For example, a time stamp 312 can be associated with the maintenance entry, indicating an approximate time of the repair action. The maintenance entry 302 can include version applicability information 314. For example, if the maintenance entry 302 is applicable to earlier versions of the system being repaired, then an “L: Ver.” indicator will be displayed (see FIG. 3M). Similarly, if the maintenance entry 302 is applicable to a subsequent version of the system being repaired, this fact can be indicated by the presence of an “H: Ver.” indicator.

Learning

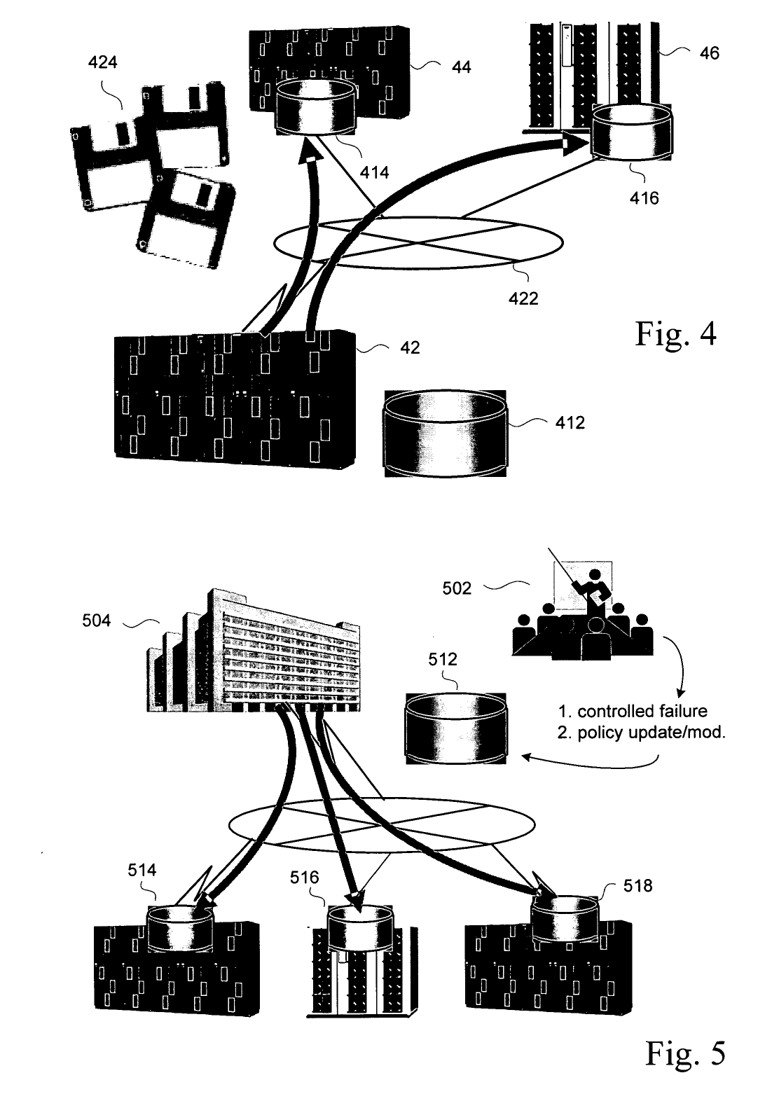

Refer now to FIG. 4 for a discussion of sharing of an SCM database. The figure shows three computer systems 42-46. Each computer system is associated with an SCM database 412-416, respectively. An SCM database can share its maintenance entries with other SCM databases. In FIG. 4, an SCM database 412 contains maintenance entries accumulated over time. The SCM database 412 contains maintenance/repair actions made on its associate target computer system 42. To the extent that other target computer systems such as computer systems 44 and 46 are similar, then the SCM databases 414, 416 associated with those computer systems may learn from the maintenance/repair experience possessed by the SCM database 412. Conversely, the SCM database 412 can “learn” from the experiences of the other SCM databases.

FIG. 4 shows that some or all of the maintenance entries of the SCM database 412 can be communicated to the other SCM databases 414 and 416. As can be seen in FIG. 4, the information can be communicated over a suitable communication network. Configuration information relating to each computer system 42-46 can be communicated via suitable media 424 (e.g., optical disk, floppy disk, etc.). Such configuration information can be used to determine which maintenance entries in an SCM database are appropriate for sending. For example, a storage subsystem might be common among the computer systems 42-46. The bit string corresponding to the constituent components of the storage subsystem would be the same among the SCM databases. Consequently, maintenance entries for failures in the storage subsystem could be shared among the corresponding SCM databases 412-416.

The SCM database can perform this task of sharing its information in an automated fashion. A system administrator can schedule sessions for uploading information to other databases. The SCM database can provide a facility that allows a user to manually perform an upload operation. In addition, the user can be provided with an interface to select specific maintenance entries and specific databases. This would provide flexibility in how the information is disseminated among the databases.

In addition, the H-Ver. and L-Ver. indicators (e.g., shown in FIG. 3M) can be used to ensure interoperability of maintenance entries that are communicated among the systems. For example, suppose a candidate system that is targeted to receive maintenance entries is an earlier version than the system 42 that contains the SCM database 412. In that case, only those entries in the SCM database 412 which included the “L: Ver.” indicator would be communicated to that target system. Conversely, suppose a candidate system that is targeted to receive maintenance entries is a later version than the system 42 that contains the SCM database 412. In that case, only those entries in the SCM database 412 which included the “H: Ver.” indicator would be communicated to that target system.

FIG. 5 shows a remote center 504 where a system support staff 502 can meet to develop new maintenance/repair procedures and strategies. This represents another source of information for creating maintenance entries in the SCM database. Whereas in the foregoing discussion, a maintenance action was triggered by some condition of the computer system itself, here controlled failures are created. The system support staff collaborates on these “what-if” failure scenarios to develop recovery/repair plans for future failures. A suitable maintenance entry (e.g., 302, FIG. 3M) can be created for each failure scenario and stored in the SCM database 512. Different failure scenarios may be created for different computer systems, to accommodate for the particular configuration of any given computer system. The information in the SCM database can be disseminated as discussed in connection with FIG. 4.

FIG. 5 further shows that new policies, policy updates/modifications can be disseminated among the SCM databases. Policies refer to maintenance and/or repair information such as schedules, procedures, and so on. The figure shows such policy changes emanating from the support staff 502. However, policy changes might originate from equipment suppliers, or other sources. When an SCM database receives a new policy or a modified or otherwise updated policy, it can update its maintenance entries to reflect the new policies. Consider FIG. 3M, for example. A new policy might include a replacement procedure for “Procd. 3B-1B.” In that case, maintenance entries referring to “Procd. 3B-1B” can be effectively modified to reference the replacement procedure.

Another scenario is preemptive in nature, wherein members of the remote center 504 discover or otherwise learn of a serious bug in one of the computer systems. Here, a solution that is determined to be effective in the failed computer system can be disseminated to other systems so that if the bug shows up, a corrective action is already known. This preemptive uploading can reduce the down time when a failure occurs.

Sharing

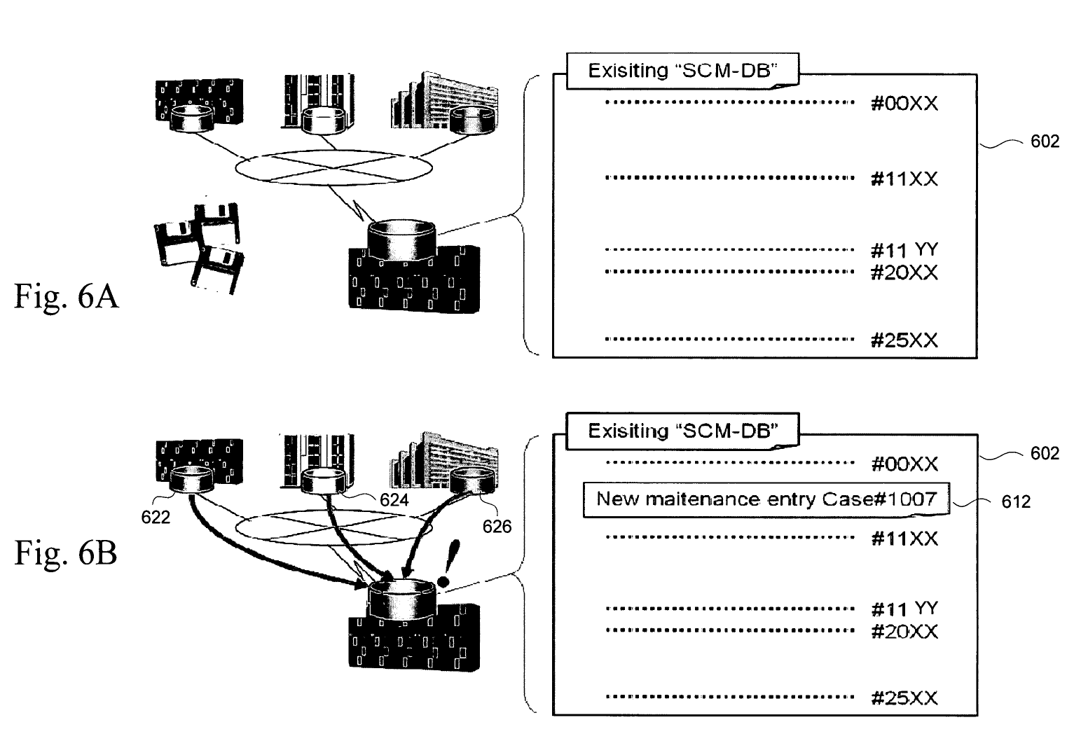

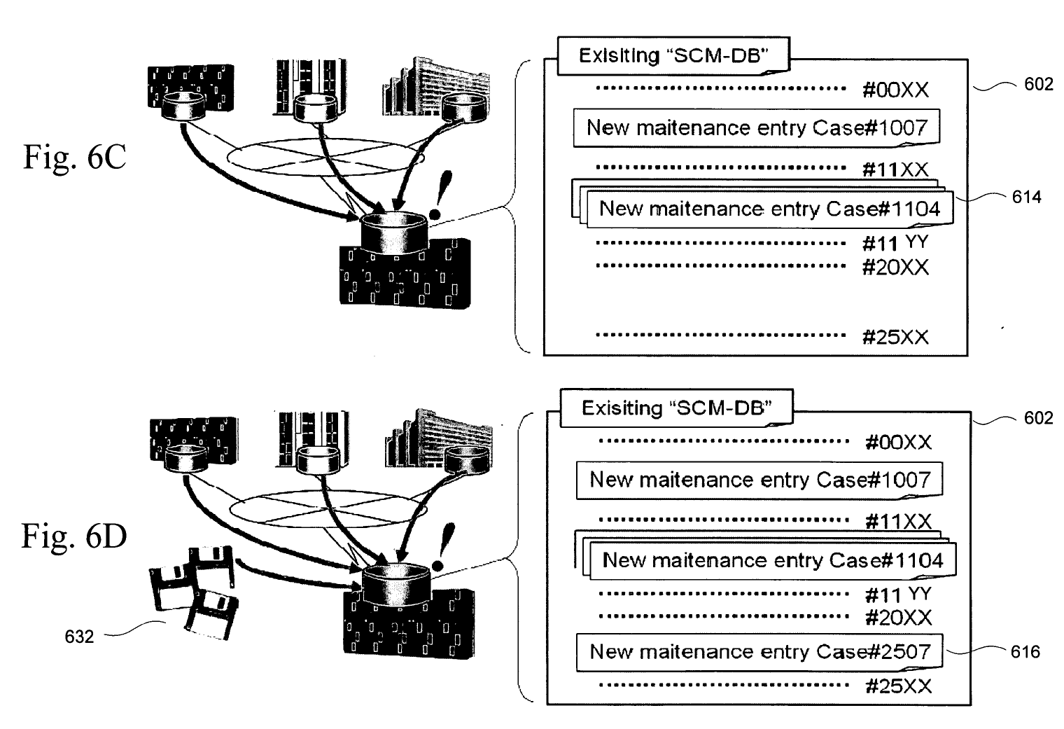

FIG. 6A illustrates an existing SCM database 602. It comprises various maintenance entries by their maintenance entry numbers (306, FIG. 3L). FIG. 6A, for example, shows that the maintenance entry numbers are arranged in increasing order; #00xx, the range #11xx through #11yy, #20xx, and #25xx, each representing a different failure with its corresponding repair actions. FIGS. 6B-6D illustrate a situation where other SCM databases 622-626 communicate with the database 602 to send new maintenance entries to the database 602. For example, FIG. 6B shows that a new maintenance entry 612 (entry identifier #1007) has been received by the database 602 from one of the other databases 622-626. The maintenance entries can be sorted by the bit patterns associated with the failure conditions.

FIG. 6C shows a situation where multiple maintenance entries 614 are received by the SCM database 602 for the same failure bitmap (i.e., the same combination of failed components). Recall, each maintenance entry represents a failure condition in which a specific combination of components have failed. Such “duplicated” maintenance entries received from other SCM databases means that failure of the same combination of components has occurred in one or more other computer systems; in addition, the repair activity is different among the multiple maintenance entries. Upon receiving duplicate maintenance entries, the receiving SCM database can order the duplicate maintenance entries according to the time stamp information 312 (FIG. 3M) associated with each maintenance entry, thus distinguishing among such duplicate entries. Thus, the multiple entries #1104, each represents the same failure combination, but different maintenance procedures, or series of repair actions and the sequence of applied repair actions.

Recall from FIGS. 4 and 5 that maintenance entries can be communicated over communication network. FIG. 6D shows that maintenance entries can be shared by disseminating removable media 632 such as optical disks, and the like. The receiving SCM database can simply upload the information contained in the media 632.

Access

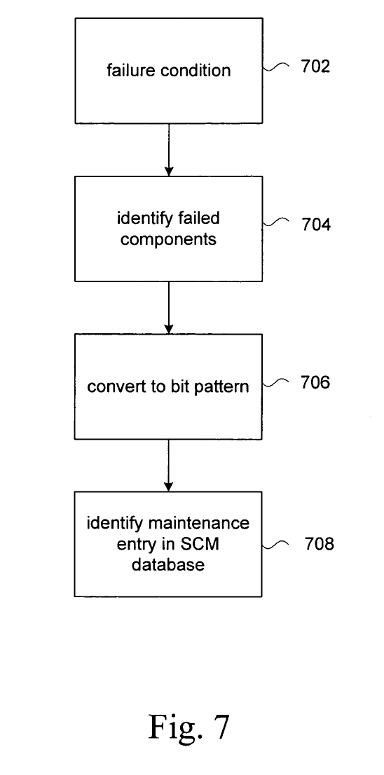

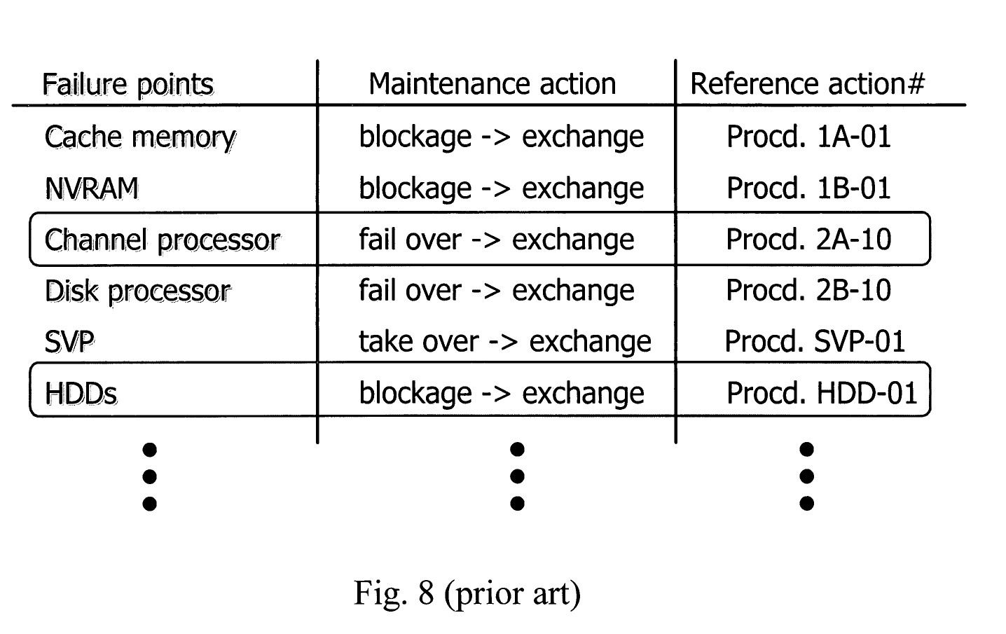

FIG. 7 outlines the process by which the SCM database can facilitate the determination of a suitable repair action for a given failure condition in a complex system. In a step 702, there is a detection or other determination that a failure condition exists that needs corrective action. As discussed above, a “failure condition” can be any situation where corrective action is deemed appropriate. The detection occurs absent human interaction; for example, sensors collecting data can detect the occurrence of a failed condition and send a suitable signal to the SCM database. Software daemons can interrogate hardware in as background processes and communicate with the SCM database to report failure conditions. In a step 704, the SCM database automatically receives indication(s) of the failed component(s).

In a step 706, the SCM database generates a pattern of bits that corresponds to the failed components identified in step 704. Recall that each component in the target computer system for which a failure can occur is associated with a bit position in a bit string. For example, a CPU may be associated with bit position 0 (least significant bit, LSB), a RAM may be associated with bit position 1, a cache memory may be associated with bit position 2, a hard drive may be associated with bit position 3, a floppy drive may be associated with bit position 4, and a CD drive may be associated with bit position 5 (most significant bit, MSB). Thus a failed CPU and a failed floppy drive would be represented by the bit pattern “0 1 0 0 0 1”, where an ON bit represents a failed component. Six bits are used to represent this trivial system. However, a typical complex system is likely to comprise many hundreds of components and thus would be represented by a bit pattern of hundreds of bits.

In a step 708, the SCM database accesses a maintenance entry based on the bit pattern that represents the failure condition. In the simple case, the SCM database contains the precise bit pattern corresponding to the failure condition. The maintenance entry that corresponds to the matching bit pattern is then output to the maintenance person. The repair entries (e.g., 304a-304d in FIGS. 3A-3M) would be performed in the order listed in the maintenance entry.

More likely, however, the bit pattern corresponding to the failure condition will not have an identical match in the SCM database. In this case, various matching algorithms can be used. For example, a simple scheme includes counting the number of bits that are ON. The matching process can then be based on the number of ON bits. A more sophisticated matching algorithm might include matching portions of the bit pattern against the SCM database. Pattern matching algorithms can be applied to locate a “close” match in the SCM database.

When a sufficiently “close” match has been found, the corresponding maintenance entry can then be produced. The matching maintenance entry, however, may list repair entries that do not apply to the given failure condition. The maintenance person nevertheless can then use the ordered list of procedures identified in the maintenance entry as a guide to making the repairs. So, although the maintenance entry did not precisely match the failure condition, the present invention nonetheless was able to provide some guidance (or at least a starting point) as to how to repair the target system.

Recall from FIG. 6C that an SCM database can contain multiple maintenance entries for a given bit pattern (i.e., failure condition). If a match hits on a bit pattern having multiple entries, the user interface can present the maintenance entry that has the most recent time stamp. The user interface instead can present the full list of maintenance entries to the user, allowing the user to examine and consider the different tactics used by various people to repair the same failure.

As can be seen from the foregoing, the present invention can greatly facilitate the repair of failures in a complex computer system. As the SCM database accumulates (learns) maintenance entries of real failures in live systems, there is less and less need to deploy highly skilled (and expensive) maintenance personnel among the many computer systems in an enterprise. The learning can be greatly accelerated by sharing information among different SCM databases in the enterprise. The quality of learning is enhanced by the fact that real failures and actual maintenance actions are the basis for learning. The SCM database accumulates real-life failures and maintenance repair experiences, and thus does not need to extrapolate, deduce, infer, or otherwise make approximations or guesses as to suitable repair actions to correct a failed condition, as might be done in conventional expert systems.

Sharing of the learned experiences among SCM databases in different systems is enhanced by ensuring that the maintenance entries are shared among compatible machines. The ability of the SCM databases to automatically share information further enhances the utility of the maintenance database according to the present invention.

The foregoing discussion used target “computer” systems merely as an example of a complex system. It can be appreciated, however, that any complex system of interconnected components, whether mechanical, electrical, electromechanical, and so on, can be treated in accordance with the present invention.

What is claimed is:

1. A method for a maintenance database to facilitate repair of failures in a target system comprising a plurality of components, the method comprising:
detecting one or more failed components in said target system absent user interaction;
producing failure information indicative of a first failure condition in said target system, said failure information representative of said failed components in said target computer system which constitute said failure condition;
receiving repair information indicative of an ordered sequence of actions performed on said target system, said ordered sequence of actions effective for repairing said target system;
generating an association between said failure information and said repair information; and
storing said failure information and said repair information along with said association therebetween as a maintenance entry in said maintenance database, said maintenance entry comprising one or more database records of said maintenance database.

2. The method of claim 1 wherein said failure information for said first failure condition is represented in said maintenance entry as a pattern of bits, each bit representing one of said components comprising said target system, wherein a bit is set to a first state if its corresponding component has failed and is set to a second state otherwise.

3. The method of claim 1 further comprising communicating one or more maintenance entries to a second maintenance database, said second maintenance database being associated with a second target system.

4. The method of claim 3 further wherein said one or more maintenance entries are selected based on similarity of components comprising said target system and said second target system.

5. The method of claim 1 further comprising creating a controlled failure condition, determining a repair sequence to repair said controlled failure condition, and creating a maintenance entry based on said repair sequence.

6. The method of claim 1 wherein said repair information refers to a plurality of repair procedures, said method further comprising generating updated repair procedures and substituting some of said repair procedures that are referenced by said repair information with one or more of said updated repair procedures.

7. A repair method for repairing a first failure condition in a target system using said maintenance database created in accordance with the method of claim 1, said repair method comprising:
identifying a plurality of failure components comprising said first failure condition;
generating a bit pattern corresponding to said failure components;
performing a matching operation to identify a candidate maintenance entry in said maintenance database the matches said bit pattern; and
performing a repair action based on said candidate maintenance entry.

8. A method for creating a maintenance database to facilitate repair of a target system comprising:
receiving information representative of a plurality of components comprising said target system;
for each component, associating a bit position in a bit string to said each component, said each component thereby corresponding to a bit;
when a failure condition in said target system is detected, identifying a plurality of failed components connected with said failure condition and setting bits in said bit string corresponding to said failed components to a first bit state, remaining bits in said bit string being set to a second bit state, a first bit pattern thereby being defined;
identifying a plurality of repair actions performed on said failed components to effect repair of said failure condition, including identifying an order by which said repair actions were performed;
associating each repair action with one of said failed components;
storing a maintenance entry comprising said first bit pattern, said repair actions, and said order by which said repair actions were performed; and
repeating said foregoing steps for a second failure condition.

9. The method of claim 8 further comprising identifying one or more maintenance entries and communication said one or more maintenance entries to at least a second maintenance database, said second maintenance database being associated with a second target system.

10. The method of claim 9 wherein said one or more maintenance entries are identified based on similarities between said target system and said second target system.

11. The method of claim 8 further comprising creating a controlled failure condition, determining a repair sequence to repair said controlled failure condition, and creating a maintenance entry based on said repair sequence.

12. The method of claim 8 wherein said repair actions refers to a plurality of repair procedures, said method further comprising generating updated repair procedures and substituting some of said repair procedures that are referenced by said repair actions with one or more of said updated repair procedures.

13. A computer system having a maintenance database to facilitate repair of failures in a target system comprising a plurality of components, the system comprising:
means for receiving failure information indicative of a first failure condition in said target system, said failure information comprising a plurality of failed components in said target computer system which constitute said failure condition;
means for receiving repair information indicative of an ordered sequence of actions performed on said target system, said ordered sequence of actions effective for repairing said target system;
means for generating an association between said failure information and said repair information; and
means for storing said failure information and said repair information along with said association therebetween as a maintenance entry in said maintenance database, said maintenance entry comprising one or more database records of said maintenance database.

14. The system of claim 13 wherein said failure information for said first failure condition is represented in said maintenance entry as a pattern of bits, each bit representing one of said components comprising said target system, wherein a bit is set to a first state if its corresponding component has failed and is set to a second state otherwise.

15. The system of claim 13 further comprising means for communicating one or more maintenance entries to a second maintenance database, said second maintenance database being associated with a second target system.

16. The system of claim 15 further wherein said one or more maintenance entries are selected based on similarity of components comprising said target system and said second target system.

17. The system of claim 13 further comprising means creating a controlled failure condition, means for determining a repair sequence to repair said controlled failure condition, and means for creating a maintenance entry based on said repair sequence.

18. The system of claim 13 wherein said repair information refers to a plurality of repair procedures, said system further comprising means for generating updated repair procedures and means for substituting some of said repair procedures that are referenced by said repair information with one or more of said updated repair procedures.
